(19) United States
(12) Patent Application Publication
(10) Pub. No.: US 2016/0332370 A1
(43) Pub. Date: Nov. 17, 2016

(54) Laser Powder Lamination Shaping Device, Laser Powder Lamination Shaping Method, and 3D Lamination Shaping Device

(71) Applicant: Hitachi, Ltd., Chiyoda-ku, Tokyo (JP)

(72) Inventors: Satoshi ARAI, Tokyo (JP); Wataru SAWADA, Tokyo (JP); Ryotaro SHIMADA, Tokyo (JP)

(21) Appl. No.: 15/110,517

(22) PCT Filed: Oct. 22, 2014
(86) PCT No.: PCT/JP2014/078014

§ 371 Date: Jul. 8, 2016

(30) Foreign Application Priority Data
Mar. 28, 2014 (JP) 2014-067462

(51) Int. Cl. B29C 67/00; B33Y 30/00; B29B 13/08; B33Y 50/02; B29C 71/04; B33Y 10/00; B33Y 40/00

(52) U.S. Cl. CPC B29C 67/0077; B29C 67/0088; B29C 67/0092; B33Y 10/00; B33Y 30/00; B33Y 40/00; B33Y 50/02; B29C 71/04; B29B 13/08; B29K 2105/251

(57) ABSTRACT

Provided is a method capable of enhancing the quality (interlaminar strength, void reduction) of a lamination shaped article and using a high-heat resistant resin, and which has low cost and good quality and does not use a process window, and enhances release properties of a support. A laser powder shaping method for fabricating a lamination shaped article, the method having a step for providing a powder material as a thin layer and a laser irradiating step for irradiating the provided powder material with a laser and thereby sintering or melting the powder material, the laser powder shaping method characterized by having a step for performing a surface modification treatment for generating or increasing the number of oxygen functional groups in a region irradiated by the laser before or after the step for providing the powder material, or before or after the laser irradiation step.

### TECHNICAL FIELD

The present invention relates to a 3D additive manufacturing method targeted at resin, and a device therefor. Further, the present invention relates to a separation method for a shaped object.

### BACKGROUND ART

The 3D additive manufacturing, because of a method in which a mold is not used has a merit that an experimental production can be performed in a short period of time, and in recent years, has been often used in the experimental production for functional confirmation. Further, in addition to the application to the experimental production, the needs for the application to the direct production of small-quantity and large-variety products have increased. In such a background, in recent years, a laser powder additive manufacturing method (in the present application, a laser powder additive manufacturing method is referred to as a laser additive manufacturing method also, a device corresponding to the method is referred to as a laser additive manufacturing device also, and a 3D additive manufacturing device or method is referred to as a 3D powder additive manufacturing device or method also) has received attention.

One of the reasons is that the laser powder additive manufacturing method is a method in which resins capable of being used in injection molding can be used, and therefore, is higher than other shaping methods in the strength, reliability and dimension stability of the shaped article.

The laser powder additive manufacturing method is a method of making a laminated article by sequentially spreading a powder material in a shaping place with a roller or a blade, selectively heating and sintering the powder material with a laser, and repeating them. In the method, for suppressing the warp at the time of the shaping, it is essential to set the surface temperature of the resin powder just before the sintering, between the melting point and recrystallization temperature of the resin, by heating means provided in the shaping place or the like at the time of the sintering. The difference between the melting point and the recrystallization temperature is often defined as a process window.

However, even when the surface temperature is set in the area of the process window, the surface temperature, actually, is often set to a temperature about 5 to 15° C. lower than the melting point of the resin, for making a good lamination shaped article, and particularly, it is known that the variation in the surface temperature on the whole shaping region deteriorates the quality of the shaped article.

Therefore, for example, Japanese Patent No. 2847579 (Patent Literature 1), Japanese Patent No. 3630678 (Patent Literature 2) and Japanese Patent No. 4856979 (Patent Literature 3) disclose means for performing the heating so as to cover the whole of the boundary of the shaping region, for stabilizing the quality.

Furthermore, in the case of the method in which the process window is used, the temperature of a shaping chamber is often at most 200° C., from the standpoint of the cost of the laser powder additive manufacturing device, and therefore, the shaping with use of a high-heat-resistance resin is difficult. Therefore, Proc. Solid Freeform Fabrication Symposium 2012 (2012) 617-628 (Non Patent Literature 1) discloses a method in which a support is adopted to the laser powder additive manufacturing and the shaped article is made with no preheat.

### CITATION LIST

### Patent Literature

PATENT LITERATURE 1: Japanese Patent No. 2847579
PATENT LITERATURE 2: Japanese Patent No. 3630678
PATENT LITERATURE 3: Japanese Patent No. 4856979

### Non Patent Literature

NON PATENT LITERATURE 1: Proc. Solid Freeform Fabrication Symposium 2012 (2012) 617-628

### SUMMARY OF INVENTION

### Technical Problem

In the case of the method in which the process window is used, a high temperature is adopted for the shaping area, and the temperature is raised to nearly the melting point. Therefore, in the case of a large shaping area, it is difficult to control the temperature variation in the shaping area, when the method in Patent Literatures 1 to 3 is used. Further, a great variation in the quality (voids and strength) is generated between the center and the edge for the case where the shaping size is large, or between shaped articles near the center and shaped articles near the edge for the case where many shaped articles are set. Further, in the powder shaping, the resin powder and a sintering part are left at a high temperature for a relatively long time, and therefore, there are also problems of the deterioration of powder providing property, the decrease in interlaminar strength, the increase in voids and the like due to the bleed of the resin (the deposition of an additive agent). Furthermore, parts where the sintering is not performed are also left at a high temperature for a long time, and therefore, the occurrence of degradation and the decrease in recycling rate also are great problems.

Further, as described in Non Patent Literature 1, when the shaped article is made with no preheat, the problem about the robustness against the temperature control and the decrease in recycling rate are solved. However, since the temperature of the resin is raised to nearly the melting point or to the temperature or higher only by laser irradiation, the temperature distribution variation in the powder resin increases, and some heat quantity easily become excessive. It is known that, as a result, many voids remain and the density of the shaped article becomes lower compared to the method in which the process window is used. Furthermore, the same kind of resin as the resin powder is used in the support member, and therefore, there is also a great problem in that it is difficult to separate it.

Hence, an object of the present invention is to provide an additive manufacturing device and an additive manufacturing method that enhance the quality of the lamination shaped article. Further, an object of the present invention is to provide a laser powder additive manufacturing device, a laser powder additive manufacturing method and a 3D additive manufacturing device by which the support member is easily separated.

### Solution to Problem

For solving the above problems, for example, configurations described in CLAIMS are employed.

The present application includes a plurality of means for solving the above problems, and an example thereof is a laser powder shaping method for fabricating a lamination shaped object, the laser powder shaping method including: a step of providing a powder material as a thin layer; and a laser irradiation step of irradiating the provided powder material with a laser and thereby sintering or melting the powder material, in which the laser powder shaping method includes a step of performing a surface modification treatment for generating or increasing an oxygen functional group in a region that is irradiated with the laser, before or after the step of providing the powder material, or before or after the laser irradiation step.

Further, an example is a laser powder shaping device that makes a 3D shaped object by sintering or melting a thin layer of a powder material with a laser and repeating a joining lamination, the laser powder shaping device including: a supply unit that supplies the thin layer of the powder material; a laser irradiation unit that sinters or melts the powder; a surface modification unit that generates or increases an oxygen functional group in a region that is irradiated with the laser; a shaping container unit that surrounds a shaping area, the shaping area being an area where the powder material is irradiated with the laser; a container that stores the powder material to be supplied to the shaping container unit and the shaping area; a piston that operates the shaping area and the storage container in a nearly vertical direction; and a heater that heats the shaping area and the shaping container.

### Advantageous Effects of Invention

By employing the present invention, it is possible to provide a lamination shaped article having a high quality.

### BRIEF DESCRIPTION OF DRAWINGS

FIG. 1 is a plan view showing the configuration of a laser powder additive manufacturing device in the present invention.

FIG. 2 is a diagram showing a laser additive manufacturing method in the present invention.

FIG. 3 is a diagram showing another embodiment of the laser additive manufacturing method in the present invention.

FIG. 4 is a diagram showing an example of the case where the laser additive manufacturing method in the present invention is applied and an overhang shape is made.

FIG. 5 is a diagram showing the shape of a support plate when the laser additive manufacturing method in the present invention is applied.

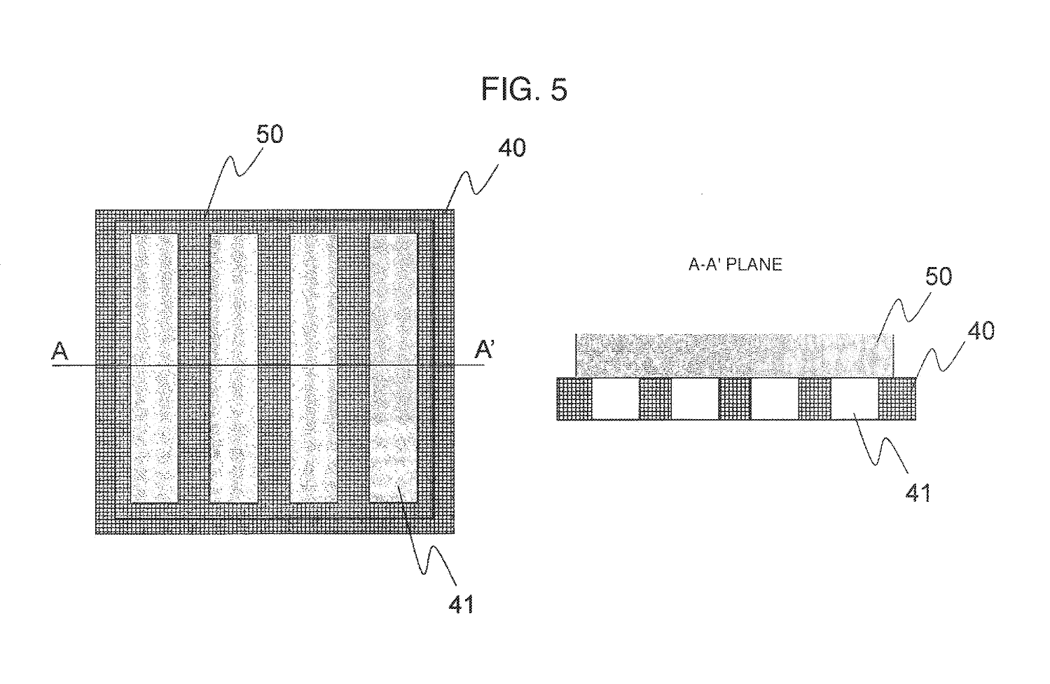

FIG. 6 is a plan view showing another embodiment of the laser powder additive manufacturing device in the present invention.

FIG. 7 is a plan view showing another embodiment of the laser powder additive manufacturing device in the present invention.

FIG. 8 is a diagram showing another embodiment of the laser additive manufacturing method in the present invention.

FIG. 9 is a diagram showing a support plate and a support shape when the laser additive manufacturing method in the present invention is applied.

FIG. 10 is a diagram showing another embodiment of the laser additive manufacturing method in the present invention and showing an example in which two kinds of powders are laminated.

### DESCRIPTION OF EMBODIMENTS

Embodiments of the present invention will be described below. A laser powder additive manufacturing device 60 to be used in the present invention is constituted by a roller 1 or a blade that supplies a powder resin 30 for supply to a shaping area, a laser source 2 that is used for sintering or melting a provided resin powder 31 and performing the lamination joining, a galvanometer mirror 3 for moving a laser beam 4 in the shaping area 8 at a high speed, a shaping container 5 in the shaping area 8, a reflecting plate 7, a storage container 6 that stores a powder material to be arranged on both sides of the shaping container 5, pistons 10, 11 for moving the shaping container 5 and the storage container 6 in the up-down direction, and a heater (not illustrated) for keeping the shaping area 8, the shaping container 5 and the storage container 6 at a high temperature. Here, the arrangement and structure of the heater may be appropriately changed. It is preferable that the area temperature 9 in the container 6 for storing the powder material (powder resin) be equal to or lower than the temperature in the shaping area 8.

The additive manufacturing is a method of making a shaped article 50 three-dimensionally by spreading the powder with the roller 1 or the blade, sintering or melting the provided resin powder 31 with the laser beam 4 and repeating them. After the shaping, the shaped article 50, which is in a state of being buried in the resin powder 32, is taken out of the resin powder 32, and thereafter, the powder is separated from the shaped article 50 by a blast or the like. Here, in the shaping area 8, for suppressing the degradation of the powder, it is desirable to decrease the oxygen concentration by performing a purge with nitrogen, argon or the like. Further, it is necessary to change the laser source 2 depending on the absorption property of the resin powder. In the case of using a natural color, it is general to use a CO₂ laser (a wavelength of 10.6 μm). In the case of containing a material that absorbs an infrared light such as black as the color of the resin powder, a fiber laser, a YAG laser and a semiconductor laser (a wavelength of 800 to 1100 nm) may be used in addition to the CO₂ laser. Ordinarily, the intensity distribution of the laser beam 4 has a Gaussian shape, but the adoption of a top hat shape allows for a high definition. It is preferable that the size of the resin powder to be used be about φ 10 to 100 μm.

For performing the additive manufacturing, in the laser powder additive manufacturing device 60, a 3D CAD model is often used as the design of the shaped object, in advance. In the additive manufacturing, based on the CAD model, an operation procedure to be performed in each step, for example, an irradiation order of the laser irradiation is set for each layer. The setting may be performed by a computer (not illustrated) used for the design or a computer separately connected through a network or the like, and may be performed in any mode. Further, the setting may be performed by the laser powder additive manufacturing device 60.

The information about the 3D CAD model or the operation procedure set by the 3D CAD model, and the like are saved in a storage unit of the laser powder additive manufacturing device 60, and the additive manufacturing is performed using the saved information. For saving or inputting the information about the above 3D CAD model or the operation procedure and the like in the storage unit, the information about the above operation procedure may he input by sending/receiving or the like with another computer, using means for using the communication through a network or the like, or separately using a storage device such as an optical disk including a CD-ROM, an MO and a flash memory.

### Embodiments

The present invention will be described with a laser powder additive manufacturing method, as a representative example of the 3D additive manufacturing.

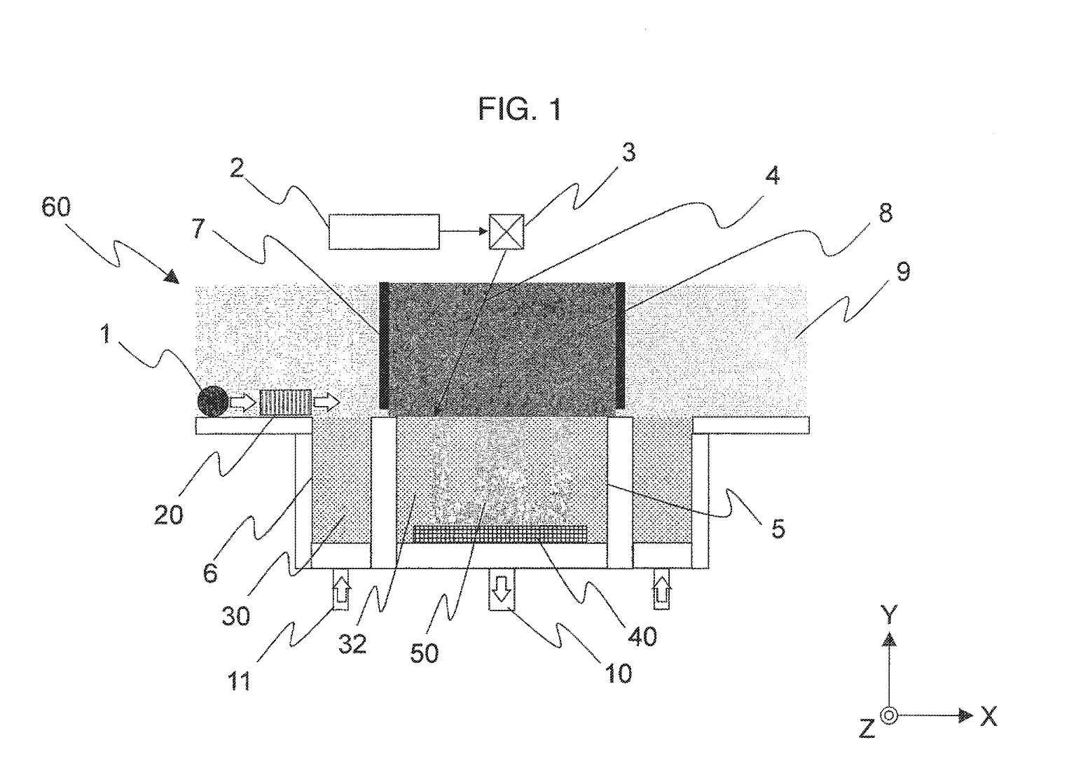

FIG. 1 is a plan view showing an embodiment of the additive manufacturing method and device in the present invention. In laser powder shaping, the powder (the resin powder or the powder resin is referred to as merely the powder also) is sintered, and thin layers are made. Therefore, there is a problem in that the sintering strength between the thin layers, that is, the sintering strength in the Z-direction (vertical direction) is low. Particularly, the powder, before the sintering with the laser beam 4, adheres tightly to a sintering part only by its own weight, and voids between the layers are easily generated.

Further, for suppressing the warp at the time of the shaping in which the fabrication of the thin layer is repeated, the shaping area 8 at the time of the shaping is often set to a temperature about 5 to 15° C. lower than the melting point of the resin material, by a heating with a heater or the like that is provided in the shaping place or the like. This is referred to as a process window scheme.

Furthermore, for suppressing the warp of the shaped article 50 buried in the resin powder 32, it is necessary to keep the shaped article 50 at a high temperature near the recrystallization temperature. Therefore, the resin powder 31 and the shaped article 50 are subjected to a high temperature for a long time, and also the deposition (bleed) of an additive agent contained in the resin material sometimes becomes a problem. In the case where the bleed occurs conspicuously, it is sometimes difficult to normally spread the powder itself on the thin layer, depending on the kind of the resin powder.

Furthermore, for exhibiting a high strength, it is necessary for the resin powder 31 to sufficiently get wet with the sintering part 33. However, by the bleed effect of the sintering part 33, the wettability decreases, and a substantial decrease in the strength between the thin layers and a substantial increase in voids sometimes occur.

In view of such a problem, the present inventors have found that the partially melted resin powder 31 sufficiently gets wet with the sintering part 33 by performing a surface modification treatment (hereinafter, referred to as merely a “modification treatment” also) for the sintering part 33 before the resin powder 31 is provided, resulting in a great contribution to the enhancement of the strength between the thin layers and the void reduction.

The surface modification treatment, in addition to the removal of the bleed, further has an effect of generating or increasing oxygen functional groups such as CO, COO and C═O, by breaking CC bond and CH bond in main chains and side chains of the sintering resin. When those functional groups are generated on the surface of the sintering part 33, the surface energy itself substantially increases. Therefore, it is possible to increase the surface energy of the sintering part 33 relative to the surface energy of the resin powder 31 to be joined, resulting in the action of the enhancement of the wettability. The place where the modification treatment is performed is not only the surface, and oxygen functional groups in a region where the treatment is performed are generated or increased.

As the surface modification treatment, because of the operation on the resin powder 31, it is preferable to use a dry treatment by which the resin powder is not scattered, for example, an atmospheric pressure plasma treatment or a UV treatment (including a UV ozone treatment).

Further, for example, by plasma 21, oxygen functional groups, that is, polar groups of the sintering part 33 substantially increase, resulting in the enhancement of the resistance to static electricity. Particularly, when the influence of static electricity increases, it is even difficult to spread the resin powder 31 thinly, and an incomplete shaping occurs. Particularly, the influence of static electricity becomes more conspicuous as the size of the resin powder decreases. Furthermore, non-polar resins are more greatly influenced by static electricity, because of not containing an oxygen functional group.

Therefore, in the case of using a small-size resin powder or a non-polar resin, the powder providing property is enhanced by performing the surface modification treatment, and therefore, it is possible to suppress the incomplete shaping substantially.

Here, it is more preferable to perform the surface modification treatment also for the powder 30 itself before the supply to the shaping area 8.

Further, from the standpoint of the dimensional accuracy of the shaped article 50, in an ordinary laser powder sintering, only crystalline resins can be mainly used. The reason is because non-crystalline resins soften from the glass transition temperatures, but do not cause a drastic viscosity decrease, and as a result, do not get wet with the sintering part 33.

Hence, the surface modification treatment in the present invention is performed for the sintering part 33, and thereby, the adhesion of the powder after the laser irradiation to the sintering part 33 is substantially enhanced. Therefore, non-crystalline resins can be also used.

Further, in the conventional laser powder sintering, the temperature of the shaping area 8 is often at most 200° C., from the standpoint of the device cost, and therefore, the limit has become a great problem, even for crystalline resins. Furthermore, even when the increase in the device cost is permitted and the process window scheme is employed for a high-melting-point resin, since the resin powders 31, 32 are subjected to a high temperature of 200° C. or higher for a long time, the powders partially adhere tightly to each other, to easily become a lump (cake), and the degradation also easily occurs. Therefore, a substantial deterioration of the recycling rate of the resin powders 31, 32 becomes a problem.

Further, in the process window scheme, for suppressing the warp, the slow cooling is performed after the shaping, and the residual stress is gradually released. However, the slow cooling is performed from a state in which the temperature is high, and therefore, a substantial increase in the cooling time becomes a great problem.

Hence, in the case of using a high-melting-point resin, it is preferable to set the temperature of the shaping area 8 to the recrystallization temperature or lower and to use a support substrate 40 for suppressing the warp. Here, it is known that, when the resin after the dry treatment is left at a high temperature, the submergence of the generated or increased functional groups is accelerated and therefore the effect is very small at a high temperature. Therefore, by adopting the lowest possible shaping temperature (for example, 100° C. or lower), the effect of the surface modification treatment is further enhanced.

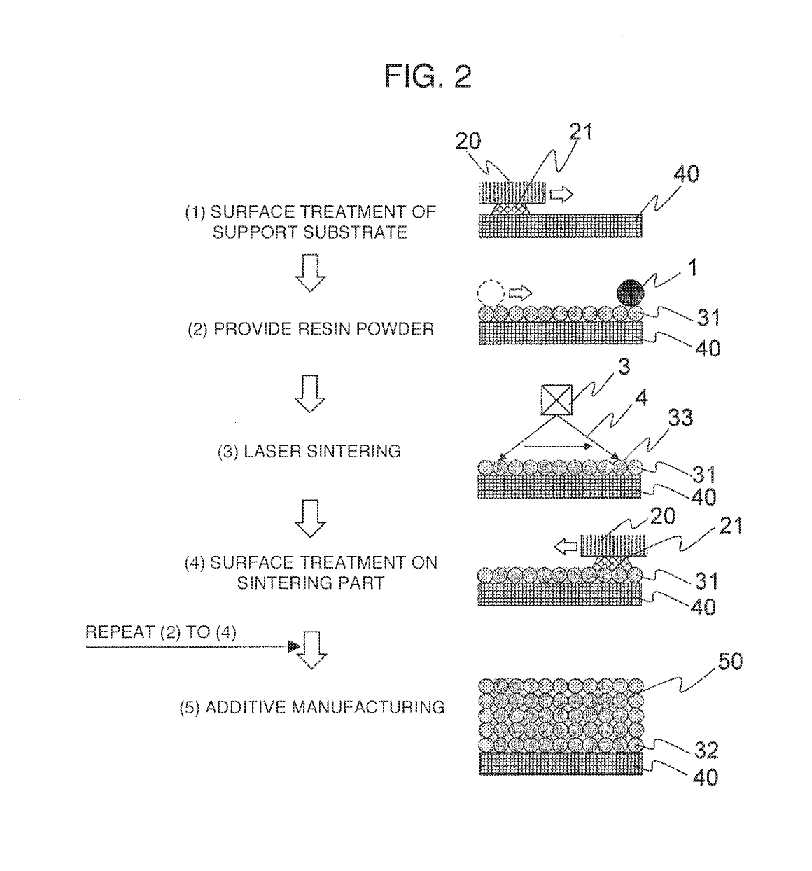

Specifically, by adopting a method shown in FIG. 2, it is possible to make the shaped article 50 having a good quality, from the resin including a high-melting-point resin. Here, although the effect of the concurrent use of the surface modification treatment for a high-melting-point resin has been mentioned, the configuration in FIG. 2 is an effective method even for a low-melting-point resin for which the process window scheme is used. Here, the above quality means interlaminar strength and void reduction.

Particularly, since the process window scheme is not used, there is a robustness against the temperature control and an effectiveness for the quality control of a large-scale shaped article 50. Further, depending on the application object of the shaped article 50, the quality may be at the same level as that in the process window scheme, and priority is sometimes given to the shortening of the shaping time.

In that case, without incorporating a surface modification treatment unit 20 within the laser powder additive manufacturing device 60, the shaping area 8 may be set to a relatively low temperature of the recrystallization temperature or lower, and then, a method with use of the support substrate 40 for which the surface treatment has been performed in advance may be employed.

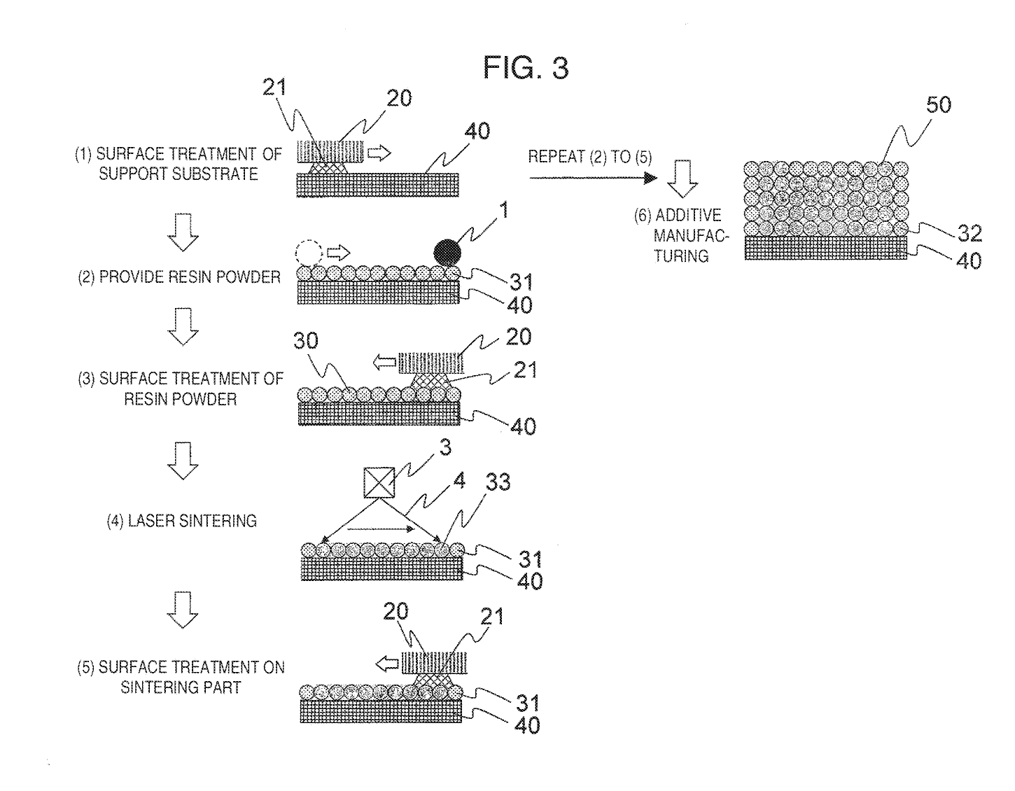

Further, in that case, it is possible to suppress the increase in the process time by the surface modification treatment and to substantially shorten the slow-cooling time. Further, to perform the surface treatment after providing the resin powder 31 in addition to the surface modification treatment of the support substrate 40 and the sintering part 33 as shown in FIG. 3 is an effective means for improving the quality.

In that case, since oxygen functional groups are increased or generated also in a gap of the resin powder 31, the adhesion between the powders in the direction orthogonal to the thickness direction is also enhanced, and the strength of the shaped article 50 is further enhanced.

In the case of using the support substrate 40 and not using the process windows scheme, the overhang shape cannot be sometimes applied.

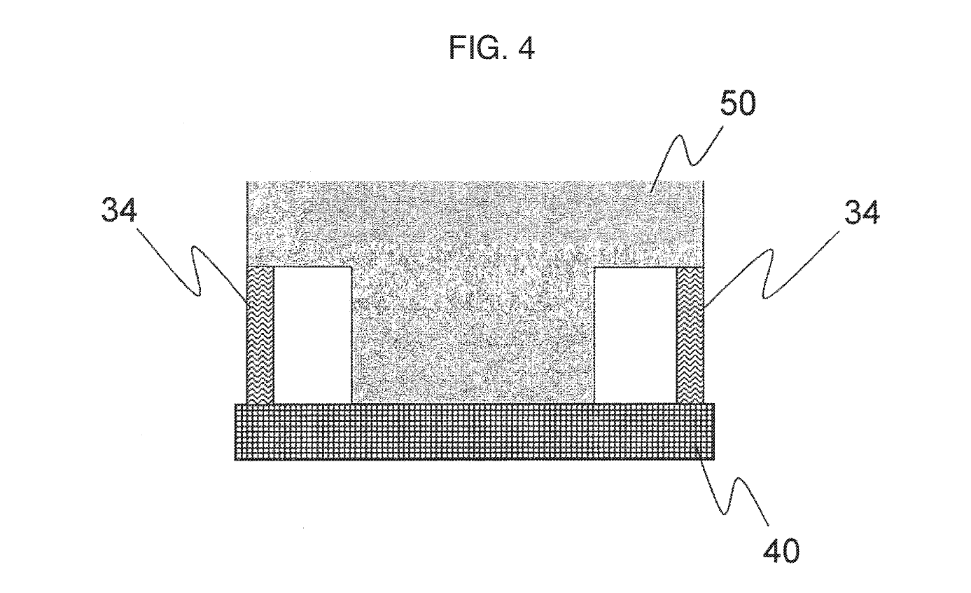

In such a case, as shown in FIG. 4, it is desirable to use a support 34 that is interposed between the support substrate 40 and the shaped article 50 and that is formed by laser sintering. The support 34, preferably, should be made by a laser energy different from that in the formation of the shaped article 50, using the same resin material as that of the shaped article 50.

Particularly, in the case of further increasing the laser energy compared to the case of the formation of the shaped article 58 a large quantity of large-size voids are formed in the resin of the support 34.

The void is not greatly influenced by the shearing stress that is generated at the time of the warp, and greatly depends on the impact strength. Therefore, when an impact stress is given at the time of the separation, the void is easily broken by the material itself of the support 34.

On the other hand, in the case of decreasing the energy compared to the above case, some powder is not melted, that is, is insufficiently sintered, at the sintering part forming the support 34. In that case, the shearing stress and the impact strength are small, and therefore, the void is easily broken by the material itself of the support 34, similarly to the above case of further increasing the energy.

However, the applicability depends also on the kind of the resin powder and the compatibility between the powder resin and the support plate. Therefore, as a method with a high robustness, it is preferable that the energy be large.

Here, in the above method in which the support substrate 40 is used, it is desirable that the material of the support substrate 40 be a resin material having a rigidity and melting point equal to or higher than those of the resin material to be used in the shaping or be a metal having a relatively low heat conductivity.

Particularly, in the case of using a resin material different from the shaping resin or using a metal having a relatively low heat conductivity, by controlling the condition of the surface modification treatment, it is possible to perform the separation between the support substrate 40 and the shaped article 50 as an interfacial fracture, resulting in a substantial enhancement of the workability.

Further, particularly, in the case where the support substrate 40 is made of a resin, it is known that an excessive surface treatment generates low molecular components with the increase in oxygen functional groups and forms a weak surface layer (WBL: Weak Boundary Layer). Therefore, it is possible to form an interfacial layer having a weaker strength than the material strength, by figuring out a stress value for suppressing the warp that can occur at the time of the slow cooling and then performing a slight surface modification or an excessive surface modification.

Further, the part and WBL joined by a slight surface treatment are weak, particularly to moisture and solvents. Therefore, after the shaping, the shaped article and the support substrate 40 are left in a high-humidity atmosphere or are immersed in a solvent or water, and thereby, the separation between them becomes easy. Furthermore, the mode of the fracture at the interface depends greatly on the impact strength, compared to the shearing stress that is generated at the time of the warp. Therefore, by giving an impact stress at the time of the separation, the interfacial fracture becomes easy.

Here, in consideration of the ease of the separation of the support substrate 40, it is further effective to provide a plurality of through holes on the support substrate 40 as shown in FIG. 3 such that only a part adheres tightly to the shaped article 50.

However, for suppressing the warp, it is preferable that the shaped article 50 and the support substrate 40 can be joined at least at the peripheral part of the shaped article 50. Further, by providing the holes 41 on the support substrate 40, it is possible to apply a load directly on the shaped article. Particularly, on the adhesion part, a separation stress to facilitate the interfacial fracture is applied, and therefore, the separation property is further enhanced.

In the case of using a metal having a relatively low heat conductivity (for example, 30 W/mK) for the support substrate 40, it is effective for the enhancement of the separation property to heat the support substrate 40 to a high temperature and then apply a separation stress.

Further, from the standpoint of the interfacial fracture between the support substrate 40 and the shaped article 50, it is desirable that the surface roughness of the support plate member be a surface roughness of a relatively smooth condition, that is, Ra 0.5 μm or less.

As the means for such a roughness, in the case where the support substrate 40 is made of a resin, it is preferable to perform mirror finish for the mold, and in the case of a material such as a metal and a ceramic, it is preferable to burnish the mold with an abrasive paper having a relatively small roughness.

Further, for example, in the case of using a metal or the like for the substrate 40 having a higher heat conductivity compared to the resin, it is possible to join the support substrate 40 and the resin powder 31 by a low-energy laser irradiation, by providing a heater at a bottom part of the support substrate 40.

Furthermore, in the case of the additive manufacturing of a shaped object (shaped model) having a small thickness, it is possible to suppress the warp of the shaped article 50 at the time of the shaping by the effect, even in a state in which the shaping area 8 is small, that is, even in a state in which the environmental temperature is low.

In the case of moving the above surface modification treatment unit 20 in the X-direction that is the same direction as the roller 1, there is a problem in that, depending on the order of them, the processes in FIG. 2 and FIG. 3 cannot be employed for all layers.

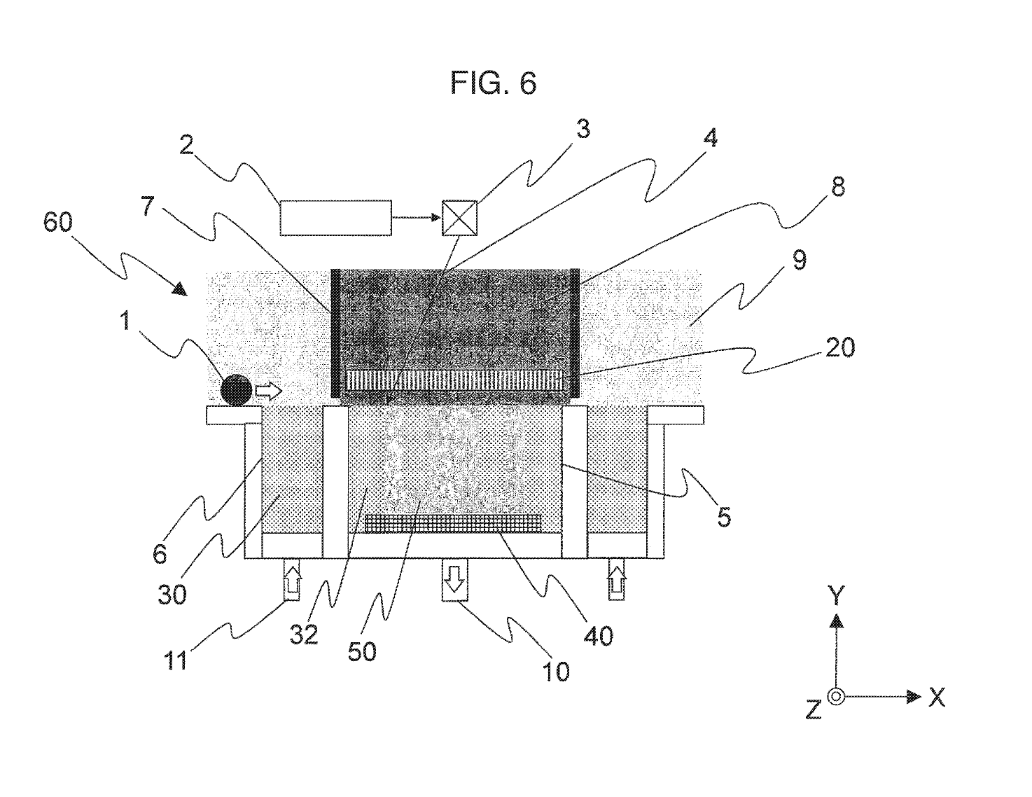

That case can be dealt with, by evacuating the surface modification treatment unit 20 in the Z-direction when the roller 1 spreads the resin powder 30. Further, in the case of moving the surface modification treatment unit 20 only in the planar direction for the reason of the configuration or price of the laser powder additive manufacturing device 60, it is preferable to arrange the roller 1 and the surface modification treatment unit 20 in a crossing manner and drive them as shown in FIG. 6.

In that case, for example, in the case where the roller 1 moves in the X-direction, the surface modification treatment unit 20 moves in the Y-direction. Naturally, they may be reversed. The above crossing angle does not need to be just 90 degrees, and may be appropriately changed.

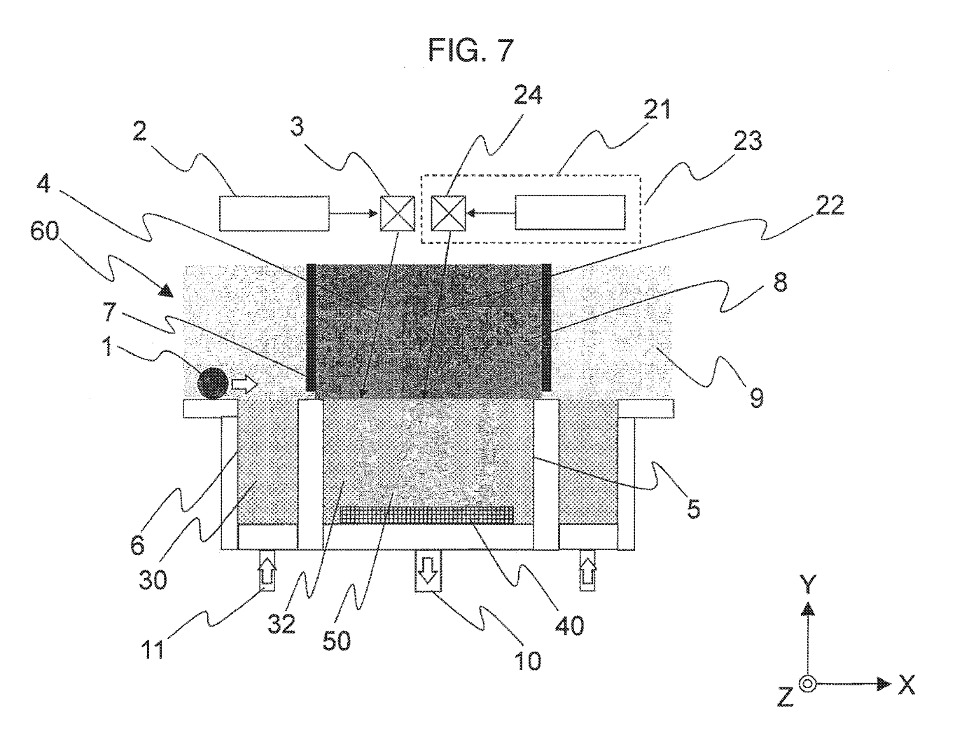

The case where the surface modification treatment unit 20 is mechanically operated similarly to the roller has been described above. As shown in FIG. 7, a UV laser (a wavelength of 300 nm or less, for example, an excimer laser) or an ultrashort laser (a pulse width of ps or less, for example, a titanium-sapphire laser) may be used.

However, the laser source 2 for the shaping and a laser source for the surface modification are greatly different, and therefore, it is difficult to share galvanometer minors 3, 24. Therefore, it is preferable to provide and operate the galvanometer mirror 24 for the surface modification near the galvanometer mirror 3 for the shaping.

The method in which the shaped article 50 is made directly on the support substrate 40 has been described above. A further formation of a support 43 on e support substrate 40 is sometimes effective.

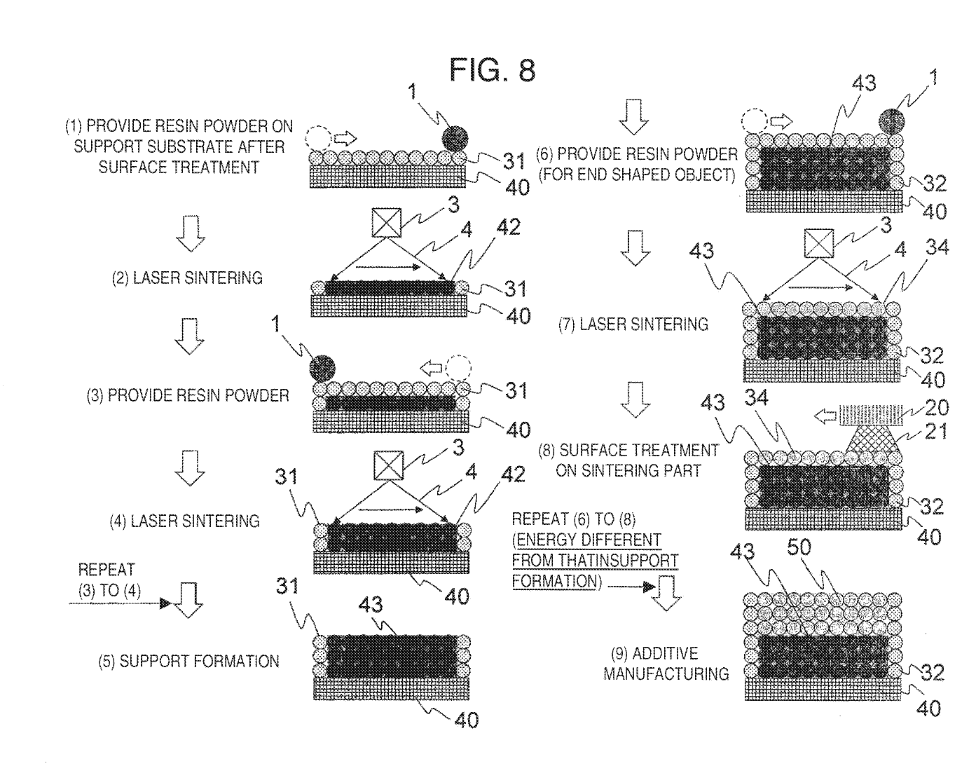

Particularly, in the case of using a powder resin that does not provide the suppression of the warp of the shaped article 50 and the enhancement of the interfacial separation property between the support substrate 40 and the shaped article 50 even when controlling the condition of the surface modification treatment and the joining area between the support substrate 40 and the shaped article 50, a support 43 composed of the same material may be provided on the support substrate 40, in a process described in FIG. 8.

On that occasion, it is preferable that the support 43 be made by shaping and the same material as that of the shaped article 50 be used, and it is desirable that the support 43 have a relation with the support substrate 40 that is employed in the overhang structure.

In that case, the support 43 is configured to he directly broken in he course of the separation between the support 43 and the shaped article 50. Here, in the case of the present invention, since the shaped article 50 and the support substrate 40 do not tightly adhere, it is possible to further increase the laser energy that is used for the joining between the support 43 and the support substrate 40.

Therefore, for the support substrate 40, a metal having a higher heat conductivity (for example, 250 W/mK or the like) can be also used. When such a material is used, the separation when the support substrate 40 is at a high temperature becomes easy. Further, the support substrate 40 such as Al in which the oxide film strength on the surface is low can be also used, and the interfacial separation between the support substrate 40 and the support 43 becomes easier.

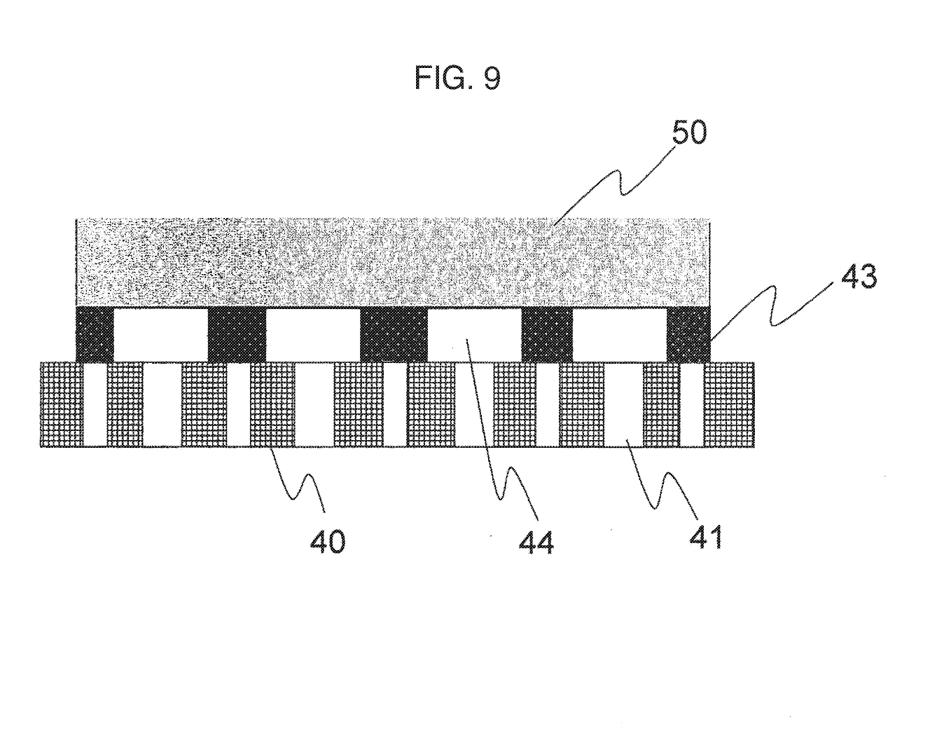

Here, in the case of using the present invention, it is preferable to adopt a structure in which through-holes 41, 44 are formed on the support substrate 40 and the support 43 and a load can be applied directly on the shaped article 50, as shown in FIG. 9.

Further, in the case where a material different from the powder resin is used for the support substrate 40, it is desirable that the joining area between the support 43 and the shaped article 50 be smaller than the joining area between the support substrate 40 and the support 43. Here, it is desirable that the rigidity of the support substrate 40 be higher than the rigidity of the support 43.

Further, similarly to the above description, it is desirable that the surface roughness of the support substrate 40 be about 0.5 μm, but in the case of the present invention, the surface roughness of the support substrate 40 may be increased up to 7.0 μm. For example, even when the resin for the support 43 goes into the surface of the support substrate 40, the separation is possible by a separate after-treatment such as the leaving wider a high temperature and a high humidity or the immersing in the solvent described above. Here, in the case where the surface roughness is larger than 7.0μm, only some of the resin penetrates, and the strength between the support 43 and the support substrate 40 becomes low.

Here, in the case where the support substrate 40 is made of a resin and is made by injection molding, the mold may be roughened and the surface of the support substrate 40 may have an embossment shape. In the case where the support substrate 40 is made of a metal, the execution of sandblast, the processing with an abrasive paper having a relatively large roughness, or the like may be performed.

Here, also in the above embodiment of the present invention, the support 34 may be used, in the case of an overhang shape. Further the number of support substrates 40 and the number of supports 34 are not limited to one, and in some cases, may be a plural number.

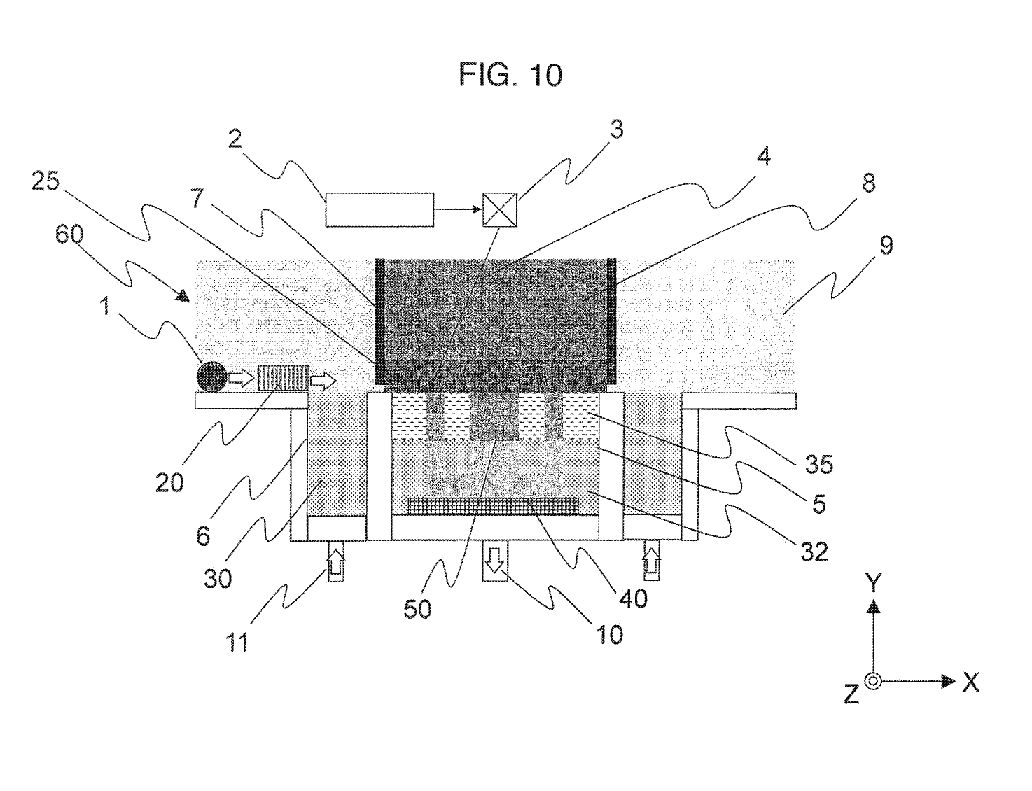

Further, each of the embodiments described above can be carried out independently, but particularly by the concurrent use of the surface modification treatment, it is possible to produce the shaped article 50 in which a different kind of powder, that is, a second powder resin 50 is laminated, as shown in FIG. 10. As the method, the methods described above may be combined, but it is desirable that the levels of the linear expansion coefficients of the powder resins be the same as much as possible.

Further, in the shaping method, the 3D CAD model is used, but for the structures of the support substrate 40 and the support 43, it is desirable to use the software incorporated in the model for the shaping. Thereby, for the shaped model, the shaping is performed in consideration of the separation place, resulting in a further enhancement of the quality of the shaped article.

Thus, it is possible to provide the method of performing the additive manufacturing in which a high-heat-resistance resin can be used and the process window is not used. Further, since the process window scheme is not used, the low lost is actualized and the quality is enhanced. Further, it is possible to actualize the ease of the separation of the support member. Further, the method greatly contributes to the enhancement of the separation property of the support. Further, it is possible to perform the direct production of small-quantity and large-variety products and to make an experimental product with use of a high resin that cannot be used conventionally. Further, it is possible to actualize the interlaminar strength and the void reduction, and to provide a lamination shaped article having a high quality.

Furthermore, the laser irradiation condition greatly varies depending on the physical properties of the materials of the support substrate 40 and the support 43, and therefore, it is more preferable that the information about the materials (the information including the information relevant to the laser irradiation condition and the shaping for the materials, which includes the information relevant to raw material, joining property and sintering, the information relevant to design, and the like, and more preferably, not only the independent information but also the shaping-relevant information configured using plural pieces of information be contained in the software. The laser irradiation condition becomes a more appropriate condition, and the quality of the shaped object becomes high.

Here, as for the powder resin material that can be employed in the present invention, the crystalline resin material having a low melting point of 200° C. or lower includes polyamide 12 (PA12), polyamide 11 (PA11), polyethylene (PE), polypropylene (PP), polyoxymethylene (POM), and the like. Furthermore the crystalline resin material having a melting point higher than 200° C. includes polybutylene terephthalate (PBT), polyphenylene sulfide (PPS), polyamide 6 (PA6), polyamide 66 (PA66), polyamide 6T (PA6T), polyamide 9T (PA9T), polyether ether ketone (PEEK), liquid crystal polymer (LCP), polyethylene terephthalate (PET), polytrimethylene terephthalate (PIT), polyethylene naphthalate (PEN), polytetrafluoroethylene (PTFE), and the like.

Further, the non-crystalline resin material includes polystyrene (PS), acrylonitrile-styrene (AS), acrylonitrile-butadiene-styrene copolymer (ABS), polymethyl methacrylate (PMMA), cycloolefin polymer (COP), cycloolefin copolymer (COC), polyvinyl chloride (PVC), polycarbonate (PC), modified polyphenylene ether (mPPE), polyether imide (PEI), polyarylate (PAR), polysulfone (PSF), polyether sulfone (PES), and the like.

Further, an alloy material in which the crystalline resin contains the non-crystalline resin to 1 to 30% is also included. Further, the crystalline resin material may contain inorganic materials such as glass, alumina and a carbon material or some metal powders to 1 to 30%, and may be a composite.

Further, an inorganic material coated with the resin material may be used. Further as the main material, not only thermoplastic resins but also thermoset resins such as epoxy-type resins and acrylic-type resins may be applied.

As the material of the support substrate 40, in addition to the above crystalline resin materials, metals (including die casts and ceramics having a heat conductivity of 250 W/mK or lower as well as SUS and Al may be used.

Thus, modes of the embodiment have been described individually. However, they are not unrelated to each other, and there is a relation in which one is a modification of a part or whole of the other. Here, it is obvious that each of the embodiments of the present invention described above can be carried out independently.

Here, as a target, the laser powder additive manufacturing method has been described above. However, the present invention is effective for other methods and devices such as an additive manufacturing method in which the lamination is performed by ejecting the melted resin from a nozzle, and an additive manufacturing method in which the lamination is performed by ejecting the resin by ink jet.

### REFERENCE SIGNS LIST

1 . . . roller, 2 . . . laser source, 3 . . . galvanometer mirror, 4 . . . laser beam, 5 . . . shaping container, 6 . . . powder storage container, 7 . . . reflecting plate, 8 . . . shaping temperature area, 9 . . . storage temperature area, 10, 11 . . . piston, 20 . . . surface modification unit, 21 . . . plasma, 22 . . . laser beam, 23 . . . laser source, 24 . . . galvanometer mirror, 30 . . . resin powder for supply, 31 . . . resin powder (after provided with the roller), 32 . . . resin powder (the powder buried in the shaping container), 33 . . . laser sintering part, 34, 43 . . . support, 35 . . . second resin powder (the powder buried in the shaping container), 40 . . . support substrate, 41, 44 . . . hole, 42 . . . laser sintering part, 50 . . . shaped article, 60 . . . laser powder additive manufacturing device

1. A laser powder additive manufacturing method for fabricating a lamination shaped object, the laser powder additive manufacturing method comprising: a step of providing a powder material as a thin layer; and a laser irradiation step of irradiating the provided powder material with a laser and thereby sintering or melting the powder material,
wherein the laser powder additive manufacturing method comprises a step of performing a surface modification treatment for generating or increasing an oxygen functional group in a region that is irradiated with the laser, before or after the step of providing the powder material, or before or after the laser irradiation step.

2. The laser powder additive manufacturing method according to claim 1, wherein the surface modification treatment is a dry treatment of either one of a plasma treatment, a UV laser treatment, a short-pulse laser treatment, a UV treatment, a UV ozone treatment and a corona treatment.

3. The laser powder additive manufacturing method according to claim 1,
wherein, in the laser irradiation step, the irradiation with the laser is performed in a state in which a surface energy of a part of the powder material is smaller than that of a joining material, the part of the powder material being irradiated with the laser, the joining material being subjected to the surface modification treatment.

4. The laser powder additive manufacturing method according to claim 1,
wherein the powder material is provided on a support member that is composed of a material different from the powder material.

5. The laser powder additive manufacturing method according to claim 1,
wherein the powder material is provided on a support member that is composed of a material identical to the powder material.

6. The laser powder additive manufacturing method according claim 1,
wherein the powder material is a non-polar resin.

7. The laser powder additive manufacturing method according to claim 4,
wherein a temperature of a shaping area is equal to or lower than a recrystallization temperature of the powder resin, the shaping area being an area where the powder material is irradiated with the laser, and the support member supports the lamination shaped article.

8. The laser powder additive manufacturing method according to claim 4,
wherein a temperature of a shaping area is equal to or lower than a glass transition temperature of the powder resin, the shaping area being an area where the powder material is irradiated with the laser, and the support member supports the lamination shaped article.

9. The laser powder additive manufacturing method according to claim 4,
wherein the support member is made of a material that is higher in rigidity than the powder resin.

10. The laser powder additive manufacturing method according to claim 4,
wherein a surface roughness of the support member is Ra 0.5 μm or less.

11. The laser powder additive manufacturing method according to claim 4,
wherein the support member is heated so as to have a temperature higher than a temperature of a shaping area, the shaping area being an area where the powder material is irradiated with the laser.

12. The laser powder additive manufacturing method according to claim 4,
wherein a support member different from the support member is formed by powder shaping.

13. The laser powder additive manufacturing method according to claim 4,
wherein a hole passing through the support member is provided on the support member.

14. The laser powder additive manufacturing method according to claim 1,
wherein the step of providing the powder material is performed using a second powder material different from the powder material, after the surface modification step is performed at least once.

15. A laser powder additive manufacturing device that makes a 3D shaped object by sintering or melting a thin layer of a powder material with a laser and repeating a joining lamination, the laser powder additive manufacturing device comprising:
a supply unit that supplies the thin layer of the powder material; a laser irradiation unit that sinters or melts the powder; a surface modification unit that generates or increases an oxygen functional group in a region that is irradiated with the laser, a shaping container unit that surrounds a shaping area, the shaping area being an area where the powder material is irradiated with the laser; a container that stores the powder material to be supplied to the shaping container unit and the shaping area; a piston that operates the shaping area and the storage container in a nearly vertical direction; and a heater that heats the shaping area and the shaping container.

16. A 3D additive manufacturing device for fabricating a lamination shaped object, the 3D additive manufacturing device having a step of providing a powder material as a thin layer and a powder material treatment step of sintering or melting the provided powder material,
wherein the 3D additive manufacturing device has a step of performing a surface modification treatment for generating or increasing an oxygen functional group, for a region of the provided powder material to be sintered or melted, before or after the step of providing the powder material, or before or after the powder material treatment step.
